(19) United States
(12) Patent Application Publication
(10) Pub. No.: US 2025/0213903 A1
(43) Pub. Date: Jul. 3, 2025

(54) SYSTEMS AND METHODS FOR DETECTING AND SUPPRESSING VEHICLE TRAILER FIRES

(71) Applicant: Torc Robotics, Inc., Blacksburg, VA (US)

(72) Inventors: Joseph R. Fox-Rabinovitz, Blacksburg, VA (US); Armenio Rivero, Blacksburg, VA (US); Akshay Pai Raikar, Blacksburg, VA (US)

(21) Appl. No.: 18/398,667

(22) Filed: Dec. 28, 2023

(51) Int. Cl. A62C 3/07; A62C 37/36

(52) U.S. Cl. CPC A62C 3/07; A62C 37/04; A62C 37/36

(57) ABSTRACT

A method for detecting and suppressing fires in a trailer of an autonomous vehicle. The method includes receiving, from one or more sensors, at least one sensor signal representing one or more fire-related conditions within the trailer of the autonomous vehicle, identifying one or more fire-indicative conditions within the trailer of the autonomous vehicle based on the one or more fire-related conditions, and receiving, from the one or more sensors, at least one sensor signal representing the one or more fire-indicative conditions. The method also includes releasing one or more fire-extinguishing substances from a suppression unit to a dispensing assembly and discharging the one or more fire-extinguishing substances from the dispensing assembly into the trailer of the autonomous vehicle.

### TECHNICAL FIELD

The field of the disclosure relates generally to autonomous vehicles and, more specifically, to systems and methods for using sensor data to detect and suppress fires in the trailer of an autonomous vehicle.

### BACKGROUND OF THE INVENTION

At least some known autonomous vehicles may implement four fundamental technologies in their autonomy software system: perception, localization, behaviors and planning, and motion control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies may process features in the sensed environment to correlate, or register, those features to known features on a map. Additionally, localization technologies may use data received from sensors and/or various odometry information sources to generate an estimated vehicle location in the world.

Behaviors and planning technologies determine how to move through the sensed environment to reach a planned destination, processing data representing the sensed environment and localization or mapping data to plan maneuvers and routes to reach the planned destination. Motion control technologies translate the output of behaviors and planning technologies into concrete commands to the vehicle via the vehicle interface provided by the internal electronic control unit (ECU).

One element of perception for autonomous vehicles is vehicle trailer condition detection and identification. During operation, a condition within the vehicle trailer may make further operation of the autonomous vehicle unsafe. For example, a fire-related condition may be detected within the trailer by the vehicle. However, without appropriate behaviors and planning input into motion control, an autonomous vehicle that detects these conditions within the trailer may be unable to safely continue movement towards a planned destination. Additionally, without deploying one or more suppression measures to reduce and/or remove the risk posed by the condition within the trailer, an autonomous vehicle that detects these conditions within the trailer may be unable to continue operation due to posing a safety risk to the autonomous vehicle and other vehicles on the road. Accordingly, there exists a need for systems and methods for detecting and suppressing trailer fires of an autonomous vehicle using sensor data of conditions within the trailer.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

The embodiments described herein relate to a system for detecting and suppressing fires in a trailer of an autonomous vehicle. The system includes a pod assembly comprising a fire detection system and a fire suppression system, and a processing system. The pod assembly is positioned in the trailer of the autonomous vehicle. The fire detection system includes one or more sensors and the fire suppression system includes a suppression unit containing one or more fire-extinguishing substances and a dispensing assembly. The processing system includes a processor and a memory device, the memory device storing instructions that when executed cause the processor to receive, from the one or more sensors, at least one sensor signal representing one or more fire-related conditions within the trailer of the autonomous vehicle, identify one or more fire-indicative conditions within the trailer of the autonomous vehicle based on the one or more fire-related conditions, receive, from the one or more sensors, at least one sensor signal representing the one or more fire-indicative conditions, release the one or more fire-extinguishing substances from the suppression unit to the dispensing assembly, and discharge the one or more fire-extinguishing substances from the dispensing assembly into the trailer of the autonomous vehicle.

The embodiments described herein also relate to a method for detecting and suppressing fires in a trailer of an autonomous vehicle. The method includes receiving, from one or more sensors, at least one sensor signal representing one or more fire-related conditions within the trailer of the autonomous vehicle, identifying one or more fire-indicative conditions within the trailer of the autonomous vehicle based on the one or more fire-related conditions, and receiving, from the one or more sensors, at least one sensor signal representing the one or more fire-indicative conditions. The method also includes releasing one or more fire-extinguishing substances from a suppression unit to a dispensing assembly, and discharging the one or more fire-extinguishing substances from the dispensing assembly into the trailer of the autonomous vehicle.

The embodiments described herein further relate to a processing system for detecting and suppressing fires in a trailer of an autonomous vehicle. The processing system comprises a processor and a memory device, the memory device storing instructions that when executed cause the processor to receive, from one or more sensors, at least one sensor signal representing one or more fire-related conditions within the trailer of the autonomous vehicle, identify one or more fire-indicative conditions within the trailer of the autonomous vehicle based on the one or more fire-related conditions, receive, from the one or more sensors, at least one sensor signal representing the one or more fire-indicative conditions, release one or more fire-extinguishing substances from a suppression unit to a dispensing assembly, and discharge the one or more fire-extinguishing substances from the dispensing assembly into the trailer of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a side view of a vehicle including an embodiment of a fire detection and suppression system.

FIG. 2 is a schematic of a processing system for use with a vehicle including a fire detection and suppression system.

FIG. 3 is a flow diagram of a method for detecting and suppressing trailer fires of a vehicle.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

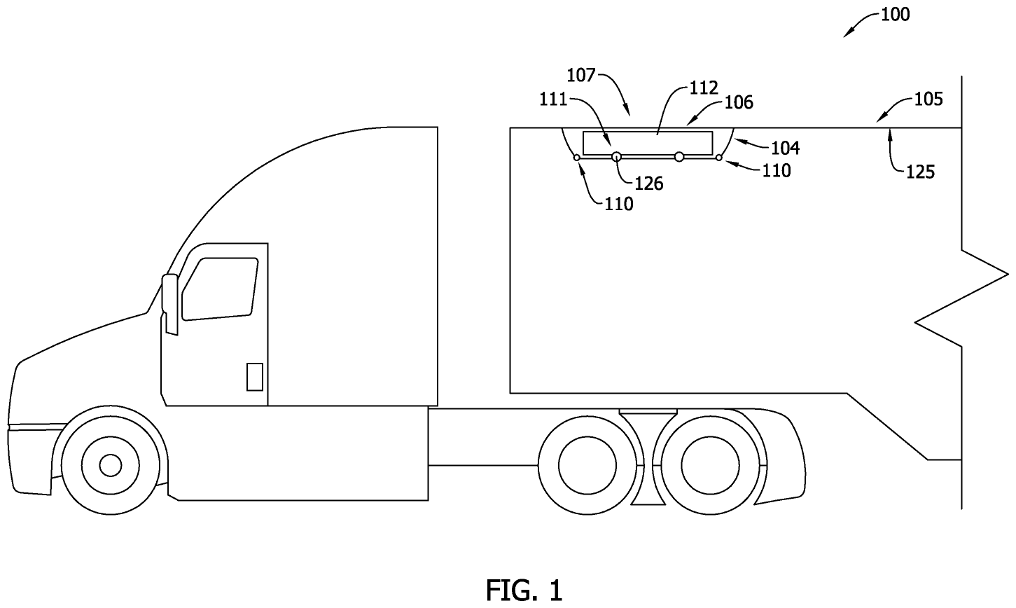

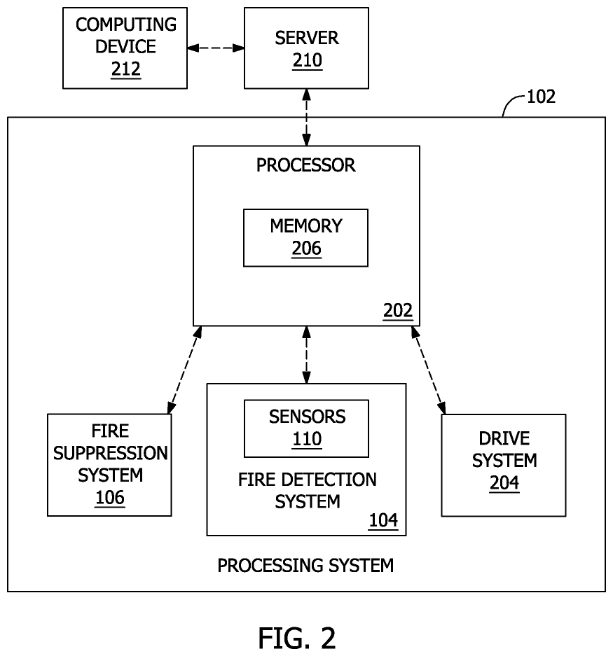

FIG. 1 is a side view of a vehicle 100. The vehicle 100 is configured for autonomous operation via a processing system 102 (shown in FIG. 2). The vehicle 100 includes a fire detection system 104 for perceiving conditions within a trailer 105 of the autonomous vehicle, including, but not limited to, fire-related conditions and fire-indicative conditions. The vehicle 100 also includes a fire suppression system 106 for releasing substances into the trailer 105 of the autonomous vehicle, including, but not limited to, fire-extinguishing substances. The processing system 102 may be used to control the vehicle 100 based on the fire-related conditions and/or the fire-indicative conditions, such as to engage the fire suppression system 106, control movement of the vehicle 100, and/or plan movement of the vehicle 100.

The fire detection system 104 and the fire suppression system 106 are housed in one or more pods 107 positioned in the trailer 105 of the vehicle 100. In some embodiments, the pod 107 is removeable in its entirety from the trailer 105, such that the fire-extinguishing substances and/or components of the fire suppression system 106 may be configured based on the chosen pod. In other embodiments, the fire suppression system 106 is detachable from the pod 107 and removeable from the trailer 105, such that the fire-extinguishing substances may be configured based on the chosen pod. In some embodiments, the pod 107 may be coupled (e.g., mechanically and/or communicatively) to the vehicle 100, such that the pod 107 may be operated when the vehicle 100 is providing power. In other embodiments, the pod 107 may also include a power source (not shown in Figures) not coupled (e.g., mechanically and/or communicatively) to the vehicle 100, such that the pod 107 may be operated when the vehicle 100 is not in use and providing power.

The fire detection system 104 includes one or more sensors 110 to detect fire-related conditions within the trailer 105, such as, but not limited to, an amount of carbon dioxide, carbon monoxide, and/or other chemicals, a smoke amount, and a temperature. The one or more sensors 110 may be any sensor known in the art that facilitates the collection of data as related to the fire detection system 104. For example, the one or more sensors 110 may include, but are not limited to, one or more infrared sensors, one or more chemical sensors, one or more optical sensors, one or more ionization sensors, and/or one or more temperature sensors.

The fire suppression system 106 includes a dispensing assembly 111 and a suppression unit 112. The suppression unit 112 contains one or more fire-extinguishing substances (not shown in Figures). The dispensing assembly 111 includes one or more dispensing nozzles 126 to convey (e.g., discharge) the fire-extinguishing substances from the suppression unit 112 into the trailer 105. To facilitate removability of at least components of the pod 107, the suppression unit 112 may contain the one or more fire-extinguishing substances (not shown in Figures) in a single tank of a portable size. For example, a smaller and/or more lightweight suppression unit 112, the one or more fire-extinguishing substances (not shown in Figures) contained in the suppression unit 112 may include a compressible fluid, a foam, and/or a powder. Additionally, for example, the suppression unit 112 may contain one or more fire-extinguishing substances (not shown in Figures) based on one or more contents stored in the trailer 105 of the vehicle 100.

The one or more sensors 110 are coupled to the pod 107 and thereby positioned within the trailer 105 of the vehicle 100. For example, the pod 107, and thereby the fire detection system 104 and the fire suppression system 106, may be positioned proximate a top interior surface 125 of the trailer 105 and the one or more sensors 110 may be spaced along the pod 107 to detect conditions throughout the trailer 105. Additionally, the one or more dispensing nozzles 126 may be spaced along the pod 107 to discharge the fire-extinguishing substances throughout the trailer 105. The shape and location of the pod 107 in FIG. 1 is intended to be illustrative, and is therefore not meant to be limiting. That is, the pod 107 may be positioned on any interior surface of the trailer 105.

FIG. 2 is a schematic of the processing system 102 for use with the vehicle 100. The processing system 102 may be used with any embodiment of the fire detection system 104 and/or the fire suppression system 106 as described herein. The processing system 102 includes a processor 202 in communication with the fire detection system 104 and the fire suppression system 106. The processor 202 may also be in communication with a drive system 204 to autonomously control movement of the vehicle 100 via a vehicle interface. The processor 202 may be one or more processing systems. The processor 202 includes a memory 206 and a processor 208. The memory 206 may be any device allowing information such as executable instructions and/or data to be stored and retrieved. The processor 208 may include one or more processing units to retrieve and execute instructions and/or data stored by the memory 206.

The processing system 102 may use signals received from the one or more sensors 110 of the fire detection system 104 to control the fire suppression system 106 and/or the drive system 204. Additionally, the processing system 102 may use signals received from a server 210. The server 210 may be in communication with a computing device 212, such as, but not limited to, a user computing device (such as for manual remote control of the fire detection system 104, the fire suppression system 106, and/or the drive system 204) and/or another vehicle in communication with the vehicle 100 to send and/or receive signals between vehicles.

The processing system 102 may control the release of fire-extinguishing substances by the fire suppression system 106. For example, the release of fire-extinguishing substances from the suppression unit 112 may be based on one or more fire-indicative conditions within the trailer 105, as identified by the processor 208 based on one or more fire-related conditions detected within the trailer 105 by the plurality of sensors 110. The plurality of sensors 110 may detect one or more fire-related conditions, such as, but not limited to, an amount of carbon dioxide, carbon monoxide, and/or other chemicals, a smoke amount, and/or a temperature sensed within the trailer 105. The processor 208 may compare the detected amount(s) to threshold amount(s) stored in the memory 206 to identify fire-indicative conditions included in the detected fire-related conditions. Upon identification of one or more fire-indicative conditions within the trailer 105, the processing system 102 may control the release of fire-extinguishing substances from the fire suppression system 106 to facilitate suppressing and/or extinguishing the identified fire within the trailer 105.

The processing system 102 may also control the motion and/or the motion planning of the vehicle 100 by the drive system 204. For example, the processing system 102 may determine a fire-suppression position for the vehicle 100 based on the fire-indicative conditions for safe operation of the vehicle 100 while the trailer fire is suppressed and/or extinguished, such as, but not limited to, a nearby shoulder and/or median of a road and/or a lane of a road safest for surrounding traffic. Additionally, for example, the processing system 102 may generate a map of one or more routes for the vehicle 100 to reach the fire-suppression position. Furthermore, for example, the processing system 102 may control the movement of the vehicle 100 to the fire-suppression position and/or on a route selected from the one or more routes to reach the fire-suppression position, including control of a velocity of the vehicle 100.

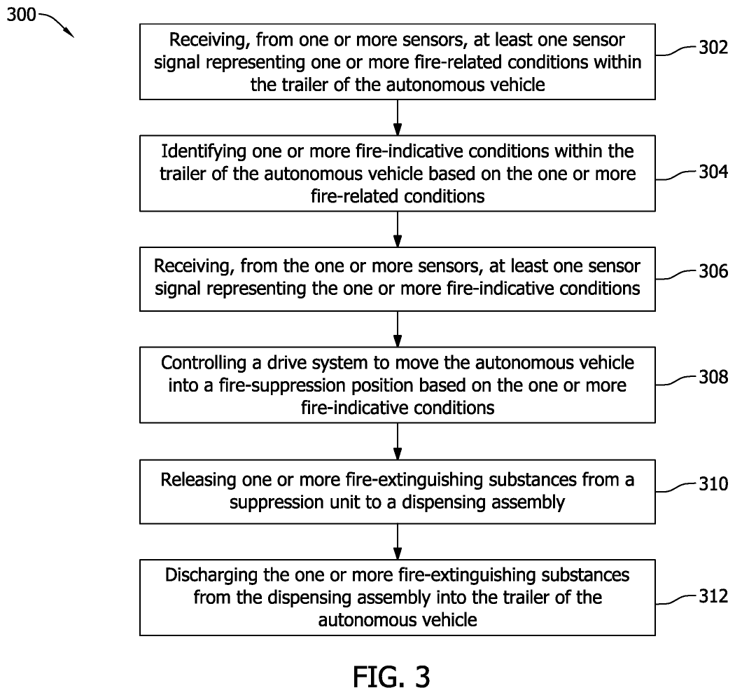

FIG. 3 is a flowchart of a method 300 of detecting and suppressing trailer fires of an autonomous vehicle, such as the vehicle 100. The method 300 includes receiving 302, from one or more sensors (such as, but not limited to, the one or more sensors 110), at least one sensor signal representing one or more fire-related conditions within the trailer (such as, but not limited to, the trailer 105) of the autonomous vehicle, and identifying 304 one or more fire-indicative conditions within the trailer of the autonomous vehicle based on the one or more fire-related conditions. The method 300 also includes receiving 306, from one or more sensors, at least one sensor signal representing the one or more fire-indicative conditions, and controlling 308 a drive system (such as, but not limited to, the drive system 204) to move the autonomous vehicle into a fire-suppression position based on the one or more fire-indicative conditions. The method 300 further includes releasing 310 one or more fire-extinguishing substances from a suppression unit (such as, but not limited to, the suppression unit 112) to a dispensing assembly (such as, but not limited to, the dispensing assembly 111) and discharging 312 the one or more fire-extinguishing substances from the dispensing assembly into the trailer of the autonomous vehicle.

Some embodiments involve the use of one or more electronic processing or computing devices. As used herein, the terms “processor” and “computer” and related terms, e.g., “processing device,” “computing device,” and “processor” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or a electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A system for detecting and suppressing fires in a trailer of an autonomous vehicle, the system comprising:
a pod assembly comprising a fire detection system and a fire suppression system, the pod assembly being positioned in the trailer of the autonomous vehicle, wherein the fire detection system comprises one or more sensors, and wherein the fire suppression system comprises a suppression unit containing one or more fire-extinguishing substances and a dispensing assembly; and
a processing system, the processing system including a processor and a memory device, the memory device storing instructions that when executed cause the processor to:
receive, from the one or more sensors, at least one sensor signal representing one or more fire-related conditions within the trailer of the autonomous vehicle;
identify one or more fire-indicative conditions within the trailer of the autonomous vehicle based on the one or more fire-related conditions;
receive, from the one or more sensors, at least one sensor signal representing the one or more fire-indicative conditions;
release the one or more fire-extinguishing substances from the suppression unit to the dispensing assembly; and
discharge the one or more fire-extinguishing substances from the dispensing assembly into the trailer of the autonomous vehicle.

2. The system of claim 1, wherein the pod assembly is removeable from the trailer of the autonomous vehicle.

3. The system of claim 1, wherein the suppression unit of the fire suppression system is removeable from the trailer of the autonomous vehicle.

4. The system of claim 1, wherein the pod assembly is mounted onto a top interior surface of the trailer of the autonomous vehicle.

5. The system of claim 1, wherein the one or more fire-related conditions comprise at least one of a carbon dioxide amount, a carbon monoxide amount, a chemical amount, a smoke amount, and a temperature.

6. The system of claim 5, wherein the one or more fire-indicative conditions are based on at least one of a carbon dioxide threshold amount, a carbon monoxide threshold amount, a chemical threshold amount, a smoke threshold amount, and a threshold temperature.

7. The system of claim 1, the system further comprising a drive system configured to move the autonomous vehicle, wherein the processor is further caused to control the drive system to move the autonomous vehicle into a fire-suppression position based on the one or more fire-indicative conditions, and wherein the fire-suppression position comprises the autonomous vehicle being stopped in or proximate to one of a road shoulder and a road lane safest for surrounding traffic.

8. The system of claim 1, wherein the one or more fire-extinguishing substances comprises at least one of a compressible fluid, a foam, and a powder.

9. The system of claim 1, wherein the pod assembly further comprises a power source not coupled to the autonomous vehicle.

10. The system of claim 1, wherein the one or more fire-extinguishing substances contained in the suppression unit of the fire suppression system are based on one or more contents stored in the trailer of the autonomous vehicle.

11. A method for detecting and suppressing fires in a trailer of an autonomous vehicle, the method comprising:
receiving, from one or more sensors, at least one sensor signal representing one or more fire-related conditions within the trailer of the autonomous vehicle;
identifying one or more fire-indicative conditions within the trailer of the autonomous vehicle based on the one or more fire-related conditions;
receiving, from the one or more sensors, at least one sensor signal representing the one or more fire-indicative conditions;
releasing one or more fire-extinguishing substances from a suppression unit to a dispensing assembly; and
discharging the one or more fire-extinguishing substances from the dispensing assembly into the trailer of the autonomous vehicle.

12. The method of claim 11, wherein receiving at least one sensor signal comprises receiving by the one or more sensors housed in a removeable pod in the trailer of the autonomous vehicle.

13. The method of claim 12, wherein releasing the one or more fire-extinguishing substances comprises releasing the one or more fire-extinguishing substances from the suppression unit housed in the removeable pod to the dispensing assembly housed in the removeable pod.

14. The method of claim 11, wherein receiving at least one sensor signal representing one or more fire-related conditions comprises receiving a signal comprising at least one of a carbon dioxide amount, a carbon monoxide amount, a chemical amount, a smoke amount, and a temperature.

15. The method of claim 14, wherein identifying one or more fire-indicative conditions is based on at least one of a carbon dioxide threshold amount, a carbon monoxide threshold amount, a chemical threshold amount, a smoke threshold amount, and a threshold temperature.

16. The method of claim 11, wherein the method further comprises controlling a drive system to move the autonomous vehicle into a fire-suppression position based on the one or more fire-indicative conditions, wherein moving the autonomous vehicle into the fire-suppression position comprises stopping the autonomous vehicle in or proximate to one of a road shoulder and a road lane safest for surrounding traffic.

17. The method of claim 11, wherein discharging the one or more fire-extinguishing substances comprises discharging at least one of a compressible fluid, a foam, and a powder.

18. The method of claim 11, wherein releasing the one or more fire-extinguishing substances from the suppression unit is based on one or more contents stored in the trailer of the autonomous vehicle.

19. A processing system for detecting and suppressing fires in a trailer of an autonomous vehicle, the processing system comprising a processor and a memory device, the memory device storing instructions that when executed cause the processor to:
receive, from one or more sensors, at least one sensor signal representing one or more fire-related conditions within the trailer of the autonomous vehicle;
identify one or more fire-indicative conditions within the trailer of the autonomous vehicle based on the one or more fire-related conditions;
receive, from the one or more sensors, at least one sensor signal representing the one or more fire-indicative conditions;
release one or more fire-extinguishing substances from a suppression unit to a dispensing assembly; and
discharge the one or more fire-extinguishing substances from the dispensing assembly into the trailer of the autonomous vehicle.

20. The processing system of claim 19, wherein the one or more sensors, the suppression unit, and the dispensing assembly are housed in a removeable pod in the trailer of the autonomous vehicle.
